(19) United States
(12) Patent Application Publication
(10) Pub. No.: US 2026/0356421 A1
(43) Pub. Date: Nov. 12, 2026

(54) METHOD FOR OPERATING A MOTOR VEHICLE, IN PARTICULAR A PASSENGER MOTOR VEHICLE, AND MOTOR VEHICLES

(71) Applicants: MERCEDES-BENZ GROUP AG, Stuttgart (DE); THYSSEN-KRUPP PRESTA AG, Eschen (DE)

(72) Inventors: Miklós Arányi, Rebstein (CH); Luc Diebold, Magstadt (DE); Ákos Dobcsányi, Mauren (LI); Dominik Lang, Feldkirch (AT); Leonard Lapis, Sennwald (CH); Magnus Rau, Kirchheim unter Teck (DE); Tobias Schlingmann, Calw (DE); Dietmar Schneider, Aidlingen (DE); Bjoern Spangemacher, Aidlingen (DE); Imre Szepessy, Mauren (CH); Jannick Widmann, Neustetten (DE)

(21) Appl. No.: 19/102,068

(22) PCT Filed: Aug. 7, 2023
(86) PCT No.: PCT/EP2023/071816

§ 371 Date: Feb. 7, 2025

(30) Foreign Application Priority Data
Aug. 9, 2022 (DE) 10 2022 119 973.8

(51) Int. Cl. B62D 5/04; B62D 9/00

(52) U.S. Cl. CPC B62D 5/0484; B62D 9/002

(57) ABSTRACT

The invention relates to a method for operating a motor vehicle (10), in which the motor vehicle (10) has a front axle (12) with front wheels (16) and a front axle steering system (24) designed as a steer-by-wire steering system, which has an electric motor (26) for actively steering the front wheels (16). The motor vehicle (10) also comprises a rear axle (14) with rear wheels (18), a rear axle steering system (32) and a torque vectoring device (34), by means of which drive torque which can be provided by a drive device (30) of the motor vehicle (10) and is distributed to the rear wheels (18) can be actively adjusted. If a malfunction of the front axle steering (24) is detected by means of an electronic computing device (36), a phase short-circuit of the electric motor (26) is specifically effected by means of the electronic computing device (36).

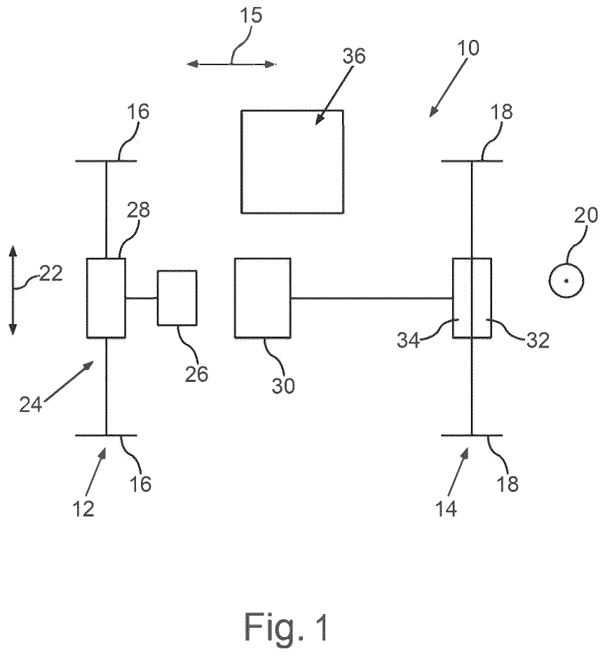

The invention relates to a method for operating a motor vehicle, in particular a passenger motor vehicle. Furthermore, the invention relates to a motor vehicle, in particular to a passenger motor vehicle.

From the general prior art, so-called steer-by-wire steering systems for motor vehicles are known, wherein the respective steer-by-wire steering is also referred to as steer-by-wire system. A steering system, thus a steering, is to be understood by such a steer-by-wire steering, in which a steering handle usually formed as a steering wheel and capable of being actuated by a person is not mechanically connected to steerable vehicle wheels such that an actuation of the steering handle is transferred via a mechanical coupling between the steering handle and the vehicle wheels to steer the vehicle wheels, but an actuation and thus a movement of the steering handle is detected by means of a sensor device and exclusively electrically transferred to a for example electromechanical actuator, which drives and thereby steers the vehicle wheels, via one or more control devices. This means that the actuation and the movement of the steering handle resulting from it is a steering command, in particular of the mentioned person, wherein this steering command is not mechanically transferred to the steerable vehicle wheels, but is detected by a sensor device and transferred to the actuator exclusively via one or more control devices, which then executes the steering command in that the actuator drives and thus steers the steerable vehicle wheels. Thus, there is no mechanical connection between the steering handle and the steerable vehicle wheels in such a steer-by-wire steering. By steering of the steerable vehicle wheels, it is to be understood that driving direction changes, cornering and lane changes of the respective motor vehicle can be effected by steering the steerable vehicle wheels.

It is the object of the present invention to provide a method and a motor vehicle such that a particularly safe operation can be realized.

This object is solved by a method with the features of claim 1 as well as by a motor vehicle with the features of claim 6. Advantageous configurations with convenient developments of the invention are specified in the remaining claims.

A first aspect of the invention relates to a method for operating a motor vehicle simply also referred to as vehicle and preferably formed as a passenger motor vehicle. In particular, the method is performed during drive of the motor vehicle, which is driven along a ground during the drive. In the method, the motor vehicle comprises at least or exactly two vehicle axles simply also referred to as axles and arranged one behind the other and thus in successive manner in vehicle longitudinal direction of the motor vehicle, namely at least or exactly one front axle and at least or exactly one rear axle. The respective vehicle axle comprises at least or exactly two vehicle wheels, wherein the vehicle wheels are also referred to as wheels. The vehicle wheels of the motor vehicle are ground contact elements, via which the motor vehicle can be or is downwards supported on the previously mentioned ground in vehicle vertical direction of the motor vehicle. When the motor vehicle is driven along the ground, while the motor vehicle is downwards supported in vehicle vertical direction on the ground via the ground contact elements, thus, the vehicle wheels, in particular directly, roll on the ground. The respective vehicle wheels of the respective vehicle axle are arranged on sides of the motor vehicle opposing each other in vehicle transverse direction of the motor vehicle. The vehicle wheels of the front axle are front wheels such that the front axle comprises the front wheels. In addition, the front axle comprises a front axle steering, which is formed as a steer-by-wire steering, thus as a steer-by-wire system. As is sufficiently known from the general prior art, such a steering is to be understood by the steer-by-wire steering, in which an actuation of a steering handle for example arranged in the interior of the motor vehicle and in particular formed as a steering wheel, effected by a person such as for example the driver of the motor vehicle, is detected by means of a sensor device, which provides an electrical actuation signal characterizing the detected actuation. The detected actuation of the steering handle is or describes a steering command. Depending on the signal, an actuator for example formed as an electrical or electromechanical actuator is controlled, thus operated, whereby the actuator drives and thereby steers, thus pivots, the front wheels, whereby the motor vehicle is steered. In particular, a movement of the steering handle effected by the person is to be understood by the actuation of the steering handle. In the steer-by-wire steering, the steering command is exclusively electrically transferred to the actuator, which executes the steering command to steer the front wheels in that the actuator drives and thereby steers the front wheels depending on the steering command. Thus, in the steer-by-wire steering, a mechanical connection is for example not provided between the steering handle and the front wheels, via which the actuation of the steering handle can be transferred to the front wheels to thereby steer the front wheels. The front axle steering comprises an electric motor for actively steering the front wheels. Thus, the electric motor is the previously mentioned actuator, by means of which the front wheels can be actively driven and thereby steered for steering the front wheels and thus the motor vehicle as a whole.

The vehicle wheels of the rear axle are also referred to as rear wheels such that the rear axle comprises the rear wheels. In addition, the rear axle comprises a rear axle steering. This means that the front wheels are steerable wheels, which can be steered by means of the electric motor to thereby be able to effect cornering, driving direction changes and lane changes of the motor vehicle. The rear wheels are also steerable wheels, which can be steered to effect driving direction changes, lane changes and cornering of the motor vehicle. Therein, it is conceivable that the rear axle is also formed as a steer-by-wire steering.

The rear axle also comprises a torque vectoring device, which is also referred to as torque vectoring unit or torque distributing unit or torque distributing device. As is already sufficiently known from the general prior art, a distribution of a drive torque capable of being provided by a drive device of the motor vehicle, also referred to as torque distribution or torque division, to the rear wheels is adjustable, that is actively variable, by means of the torque vectoring device. In other words, an active distribution of the drive torque to the individual rear wheels can be performed by means of the torque vectoring device. Hereby, it is in particular to be understood that the torque vectoring device can distribute, that is divide, the drive torque to the rear wheels, such that a first torque with a first value resulting from the drive torque for example acts on a first one of the rear wheels and a second torque with a second value resulting from the drive torque acts on a second one of the rear wheels. Therein, it is in particular conceivable that the first value and the second value differ from each other, in particular while the first torque acts on the first rear wheel and the second torque acts on the second rear wheel. In particular, the drive device can drive the rear wheels by means of the drive torque via the torque vectoring device, which can be actively distributed, that is divided, to the rear wheels by means of the torque vectoring device as described. Thus, the torque vectoring device in particular allows differently distributing the drive torque to the rear wheels such that the first torque has the first value and the second torque has the second value different from the first value at the same time. In particular, it is conceivable that the torque vectoring device is formed to selectively distribute, that is divide, the drive torque to the rear wheels such that the first torque and the second torque are in the same direction or in opposite direction such that one of the rear wheels is for example driven, while another one of the rear wheels is for example braked.

Thus, the drive device is formed to provide the drive torque and hereby to drive the rear wheels and thus the motor vehicle as a whole. In particular, the drive device can drive the rear wheels via the torque vectoring device. For example, the drive device includes at least one electrical machine, by means of which the rear wheels and thus the motor vehicle can be, in particular purely, electrically driven. Preferably, the electrical machine is formed as a high-voltage component, the electrical voltage, in particular electrical operating or nominal voltage, of which is preferably greater than 50 Volts, in particular greater than 60 Volts, and very preferably is several hundreds of Volts. Alternatively or additionally, the drive device can comprise an internal combustion engine, by means of which the rear wheels and thus the motor vehicle can be driven. Thus, the motor vehicle can be formed as a hybrid vehicle or else as an electric vehicle, in particular as a battery electric vehicle (BEV).

If a malfunction of the front axle steering is detected in the method by means of an electrical computing device, which can comprise at least or exactly one control device or multiple control devices in particular connecting to each other in terms of signaling, a phase short-circuit of the electric motor is specifically effected by means of the electronic computing device. The malfunction of the front axle steering is for example detected by means of the electronic computing device in that at least one, in particular electrical, measurement signal satisfies at least one preset criterion. For example, the measurement signal is provided by a detection device. The measurement signal for example characterizes a state of at least one component of the motor vehicle. In particular, the measurement signal for example characterizes a position, in particular a rotational or pivot position, of the component, wherein the position is for example detected by means of the detection device. For example, if the position of the component deviates from a target position, thus, the criterion is satisfied, thus, the malfunction is then detected.

In the method, if the malfunction is detected by means of the electrical computing device, the rear axle steering and the torque vectoring device are specifically controlled by means of the electronic computing device to thereby specifically steer the motor vehicle. By controlling the rear axle steering, the rear wheels are for example pivoted and thus steered, whereby the motor vehicle is steered. By controlling the torque vectoring device, the drive torque is for example specifically distributed, that is divided, to the rear wheels by means of the torque vectoring device such that the motor vehicle is steered, in particular that the rear wheels are steered. By controlling the torque vectoring device, the drive torque is for example specifically distributed to the rear wheels by means of the torque vectoring device such that the first torque has the first value and the second torque has the second value different from the first value at the same time. By specifically controlling the torque vectoring device, a torque in particular acting around the vehicle vertical direction of the motor vehicle, also referred to as yaw moment, can for example be effected, whereby a steering movement of the motor vehicle can be effected, thus the motor vehicle can in particular be specifically steered to a desired direction, in particular driving direction. Thus, the method according to the invention allows a redundant steering function at overall vehicle level such that the motor vehicle remains steerable or can be steered if the malfunction occurs. In particular, the method according to the invention allows a fallback level in case of the malfunction, in particular upon a failure of the front axle steering, to allow a transverse guidance of the motor vehicle any longer, that is despite of the malfunction. Thereby, in case of the malfunction, in particular upon failure of the front axle steering, a so-called emergency driving state can for example be realized, in which the motor vehicle can for example be specifically steered despite of the malfunction, such that the motor vehicle can still be driven to a desired location such as for example a home of the driver or to a garage despite of the malfunction, or that the motor vehicle can be steered to a curb or roadside, in particular to a shoulder or emergency lane, despite of the malfunction.

The phase short-circuit of the electric motor is for example switched on or effected by a software, thus by an algorithm also referred to as software algorithm.

For example, the front axle steering comprises a steering gear, via which the front wheels can be driven and thereby steered by the electric motor. In particular, the steering gear can comprise a steering rack for example displaceable at least in vehicle transverse direction. Further, the steering gear can for example comprise a gear wheel also referred to as pinion, which meshes with the steering rack, thus engages with the steering rack.

For example, the electric motor can drive and thereby rotate the gear wheel to thereby displace the steering rack and consequently steer the front wheels. In the method according to the invention, the phase short-circuit of the electric motor is used as blocking or damping to be able to specifically steer the motor vehicle by controlling the rear axle steering and by controlling the torque vectoring device as a consequence. In other words, the electric motor is or acts as a blocking or damping device as a result of effecting the phase short-circuit of the electric motor, in particular by a self-retention and/or friction, such that undesired pivot movements of the front wheels and/or an undesired reset of the front wheels can for example be avoided. As a result, the motor vehicle can be advantageously and in particular specifically steered by means of the rear axle steering by means of the torque vectoring device despite of the malfunction of the front axle steering.

The specific control of the rear axle steering and of the torque vectoring device is used as a redundant steering function if the malfunction, in particular a failure, of the front axle steering occurs. In particular, the electric motor acts in blocking or damping manner on the steering rack due to the phase short-circuit, to thereby for example counteract an undesired reset of the front wheels or to avoid such an undesired reset.

For example, the method can be allocated in a control device of the steer-by-wire steering or else in another intelligent control device. This is in particular possible because the method is only required or performed if the malfunction is detected, in particular if the steer-by-wire steering has failed. In particular, at least the following advantages can be realized by the invention:
Using synergies of the rear axle steering and the torque vectoring device to realize a redundant steering function for the steer-by-wire steering. Therein, the rear axle steering and the torque vectoring device are used as further actuators to generate a yaw moment acting around the vehicle vertical direction by actuator interventions, thus by controlling the further actuators, and thus to steer the motor vehicle.
By the phase short-circuit of the electric motor, the electric motor can act as a damping unit, in particular in the or on the steering gear, to for example thereby.

In order to precisely steer the motor vehicle despite of the malfunction of the front axle steering and thus to be able to realize a particularly safe operation, it is provided in an embodiment of the invention that the steering angle of the front wheels is, in particular specifically, kept constant by specifically effecting the phase short-circuit. Hereby, the motor vehicle can be precisely steered by controlling the rear axle steering, thus by steering the rear wheels, despite of the malfunction such that a particularly safe operation can be presented.

In a further particularly advantageous embodiment of the invention, it is provided that the steering angle of the front wheels, is, in particular specifically, adjusted by specifically effecting the phase short-circuit, and is for example thereafter kept constant. In particular, it is to be understood hereby that the steering angle of the front wheels is, in particular specifically, adjusted and thus changed from a first value to a second value different from the first value for example by specifically effecting the phase short-circuit and is preferably thereafter constantly kept at the second value. Thereby, a defined state, in particular a defined position, of the front wheels can for example be adjusted such that the rear wheels can be specifically steered by controlling the rear axle steering as a consequence such that the motor vehicle can be specifically and thus safely and precisely steered.

A further embodiment is characterized in that braking of at least or exactly one of the rear wheels by means of the torque vectoring device is specifically effected by controlling the torque vectoring device. Thereby, a particularly large yaw moment acting around the vehicle vertical direction can for example be effected, whereby the motor vehicle can be precisely and intensely steered. Thereby, a particularly high safety can be ensured.

Finally, it has proven to be particularly advantageous if drive, thus positive acceleration, of at least or exactly one of the rear wheels by means of the torque vectoring device is specifically effected by controlling the torque vectoring device. By driving the at least or exactly one rear wheel, it is in particular to be understood that the at least or exactly one rear wheel first rotates in one rotational direction and is accelerated by controlling the torque vectoring device such that a rotational speed, with which the at least or exactly one rear wheel rotates in the same rotational direction, is increased. In particular, it is conceivable to brake a first one of the rear wheels by means of the torque vectoring device by controlling it and to drive, that is to positively accelerate, another one of the rear wheels by means of the torque vectoring device by controlling it, whereby the motor vehicle can be particularly intensely steered.

A second aspect of the invention relates to a motor vehicle preferably formed as a passenger motor vehicle, which is also simply referred to as vehicle and is formed for performing a method according to the first aspect of the invention. Advantages and advantageous configurations of the first aspect of the invention are to be regarded as advantages and advantageous configurations of the second aspect of the invention and vice versa.

Further advantages, features and details of the invention are apparent from the following description of a preferred embodiment as well as based on the drawing. The features and feature combinations mentioned above in the description as well as the features and feature combinations mentioned below in the description of figure and/or shown in the single figure alone, are usable not only in the respectively specified combination, but also in other combinations or alone without departing from the scope of the invention.

The drawing shows a schematic representation of a motor vehicle in the single FIG.

The single FIG. shows a motor vehicle 10 formed as a passenger motor vehicle and also referred to as vehicle in a schematic representation, which for example comprises a steering handle in particular formed as a steering wheel in its interior also referred to as passenger cabin or passenger compartment. The steering handle can be actuated and thus moved by a person located in the interior such as for example the driver of the motor vehicle to thereby for example steer the motor vehicle 10, thus effect a steering movement of the motor vehicle 10. This will be explained in more detail in the following. In the following, a method for operating the motor vehicle 10 is also described based on the single FIG. The motor vehicle 10 comprises exactly two vehicle axles 12 and 14 arranged one behind the other in vehicle longitudinal direction of the motor vehicle 10, wherein the vehicle longitudinal direction is illustrated by a double arrow 15. The vehicle axle 12 is a front axle and the vehicle axle 14 is a rear axle. The respective vehicle axle 12, 14 comprises exactly two vehicle wheels 16, 18, wherein the vehicle wheels 16 of the front axle are front wheels and the vehicle wheels 18 of the rear axle are rear wheels. The vehicle wheels 16 and 18 are ground contact elements, via which the motor vehicle 10, which is also referred to as automobile, can be or is downwards supported on a ground in vehicle vertical direction. In the FIG., the vehicle vertical direction is illustrated by a double arrow 20 and extends perpendicularly to the image plane of the FIG. It is apparent that the respective vehicle wheels 16, 18 of the respective vehicle axle 12, 14 are arranged on sides of the motor vehicle 10 opposing each other in vehicle transverse direction. The vehicle transverse direction is illustrated by a double arrow 22.

The front axle includes a front axle steering 24 particularly schematically illustrated in the figure, which is formed as a steer-by-wire steering. In particular, the following is to be understood thereby: If the steering handle is actuated and thereby moved by a person located in the interior, thus, the movement of the steering handle is detected by means of a sensor device. The sensor device provides an electrical sensor signal, wherein an actuator, formed as an electric motor 26, of the front axle steering 24 is controlled and thereby operated depending on the sensor signal. Hereby, the electric motor 26 drives the vehicle wheels 16 (front wheels) , whereby the vehicle wheels 16 and thus the motor vehicle 10 are steered. Hereby, lane changes, driving direction changes and cornering of the motor vehicle 10 can for example be effected. A mechanical connection, via which the movement of the steering handle is transferred to the vehicle wheels 16 and thus can be converted into a respective steering movement of the vehicle wheels 16, does not exist between the steering handle and the vehicle wheels 16. The front axle steering 24 includes a steering gear 28 particularly severely schematically illustrated in the FIG., which for example comprises a steering rack. It is apparent that the electric motor 26 can drive and thereby steer the vehicle wheels 16 via the steering gear 28 and thus via the steering rack.

The motor vehicle 10 comprises a drive device 30 particularly schematically illustrated in the FIG., which can provide a drive torque for driving the vehicle wheels 18 and thus the motor vehicle 10 as a whole. Therein, the vehicle axle 14 (rear axle) comprises a rear axle steering 32, by means of which the rear wheels (vehicle wheels 18) can be steered. In addition, the rear axle comprises a torque vectoring device 34, wherein the drive device 30 can for example drive the vehicle wheels 18 via the torque vectoring device 34. By means of the torque vectoring device 34, a distribution of the drive torque provided or capable of being provided by the drive device 30 to the wheels is actively adjustable. In other words, the torque vectoring device 34 can specifically distribute or divide the drive torque to the vehicle wheels 18, in particular such that the drive torque is differently divided to the vehicle wheels 18 such that a first torque acting on a first one of the vehicle wheels 18 and a second torque acting on the second vehicle wheel 18 and different from the first torque for example results from the drive torque. The first torque and the second torque for example differ from each other with respect to their values, that is in terms of magnitude, and/or the first torque and the second torque for example differ from each other with respect to their respective direction of action.

In the FIG., an electronic computing device 36 is also particularly schematically shown, which is for example a constituent of the motor vehicle 10. The electronic computing device 36 can include at least or exactly one control device or multiple control devices. In other words, the electronic computing device 36 can be formed by at least or exactly one control device or by multiple control devices in particular connected to each other.

Now, if a malfunction of the front axle steering 24 is detected by means of the electronic computing device 36 in the method, a phase short-circuit of the electric motor 26 is specifically effected by means of the electronic computing device 36. In addition, if the malfunction is detected by means of the electronic computing device 36, the rear axle steering 32 and the torque vectoring device 34 are specifically controlled by means of the electronic computing device 36 to thereby specifically steer the motor vehicle 10.

For example, the malfunction is detected if it is detected that the steering angle of the front wheels cannot be measured, thus detected, by means of a detection device (anymore). For example, the detection device is provided to measure the steering angle of the front wheels and to provide a measurement signal, which characterizes the steering angle of the front wheels measured by means of the detection device. For example, if the measurement device now does not provide the measurement signal (anymore), although the measurement device is to, should or would have to provide the measurement signal, thus, the malfunction is inferred. Further, it is for example conceivable that if the measurement signal deviates from a target signal, the malfunction is inferred, thus the malfunction is detected. Thus, the malfunction in particular includes that the measurement device does not detect the steering angle of the front wheels (anymore). For example, the malfunction is detected if at least one presettable or preset criterion is satisfied. For example, the criterion is satisfied if the measurement device does not provide the measurement signal. Alternatively or additionally, the criterion is for example satisfied if the measurement signal deviates from the mentioned target signal.

By controlling the torque vectoring device 34 and the rear axle steering 32, a redundant steering function, in particular at overall vehicle level, can be presented such that a particularly safe operation of the motor vehicle 10 can be ensured.

### LIST OF REFERENCE CHARACTERS

10 motor vehicle
12 vehicle axle
14 vehicle axle
15 double arrow
16 vehicle wheel
18 vehicle wheel
20 double arrow
22 double arrow
24 front axle steering
26 electric motor
28 steering gear
30 drive device
32 rear axle steering
34 torque vectoring device
36 electronic computing device

1. A method for operating a motor vehicle, in which:
the motor vehicle comprises a front axle with front wheels and a front axle steering formed as a steer-by-wire steering, which comprises an electric motor for actively steering the front wheels;
the motor vehicle comprises a rear axle with rear wheels, a rear axle steering and a torque vectoring device, by means of which a distribution of a drive torque capable of being provided by a drive device of the motor vehicle to the rear wheels is actively adjustable;
if a malfunction of the front axle steering is detected by means of an electronic computing device:
a phase short-circuit of the electric motor is specifically effected by means of the electronic computing device;
the rear axle steering and the torque vectoring device are specifically controlled by means of the electronic computing device to thereby specifically steer the motor vehicle.

2. The method according to claim 1, wherein:
the steering angle of the front wheels is kept constant by specifically effecting the phase short-circuit.

3. The method according to claim 1, wherein:
the steering angle of the front wheels is adjusted by specifically effecting the phase short-circuit.

4. The method according to claim 1, wherein:
by controlling the torque vectoring device , braking of at least or exactly one of the rear wheels by means of the torque vectoring device is specifically effected.

5. The method according to claim 1, wherein:
by controlling the torque vectoring device, driving at least or exactly one of the rear wheels by means of the torque vectoring device is specifically effected.

6. A motor vehicle, which is formed for performing a method according to claim 1.
